(19) United States
(12) Patent Application Publication
(10) Pub. No.: US 2026/0100583 A1
(43) Pub. Date: Apr. 9, 2026

(54) SYSTEMS AND METHODS FOR HIGH VOLTAGE DIRECT CURRENT BUS COUPLING

(71) Applicant: Caterpillar Inc., Peoria, IL (US)

(72) Inventors: Prajod Krishnan Kutty, Palakkad Dist (IN); Chethan Ramakrishnaiah, Bengaluru (IN); Gregory Scott Hasler, Pekin, IL (US); Sampathkumar Nachimuthu, Bangalore (IN); Firoz Ahamed, Bengaluru (IN)

(73) Assignee: Caterpillar Inc., Peoria, IL (US)

(21) Appl. No.: 18/910,420

(22) Filed: Oct. 9, 2024

(51) Int. Cl. H02J 3/36; G05B 23/02; H02J 3/00; H02J 3/14; H02J 13/00

(52) U.S. Cl. CPC H02J 3/36; G05B 23/0221; H02J 3/0012; H02J 3/14; H02J 13/12

(57) ABSTRACT

At least one aspect of the present disclosure is directed to a high voltage direct current (HVDC) bus coupler system. The HVDC bus coupler system can include a monitoring unit to detect fault events. The HVDC bus coupler system can include a controller. The controller can include one or more processors to receive a signal indicating an event associated with at least one of a plurality of energy containers in a first configuration. The one or more processors can identify a first energy container corresponding to the event The one or more processors can determine a second configuration of the plurality of energy containers. The one or more processors can modify a configuration of the plurality of energy containers, from the first configuration to the second configuration.

### TECHNICAL FIELD

The present implementations relate generally to the field of bus coupling, and more particularly systems and method to for high voltage direct current bus coupling.

### BACKGROUND

High Voltage Direct Current (HVDC) bus coupling may be used in power transmission to connect and manage an electrical grid using direct current at high voltages. In some implementations, the direct current at high voltages may be efficient for long distance transmission as an alternative to alternating current systems. HVDC bus coupling allows for the integration of various energy sources, such as renewable energy plants, to facilitate the transfer of large amounts of electricity.

For example, U.S. Patent Application No. 2024/0006903 describes a mobile solar power unit control system providing power to an associated equipment item including: at least one mobile solar power unit comprising an assembly of inter-connected solar collector panels; an energy storage module connected to receive power from the assembly of inter-connected solar panels; and a control system for controlling operation of both the energy storage module and associated equipment item. The control system comprises a local controller onboard or proximate the at least one mobile solar power unit and a remote controller, communicable with the local controller, located remotely from said at least one mobile solar power unit. The mobile solar power unit provides power for an associated equipment item and any selected auxiliary loads located in an off-grid location.

### SUMMARY

A first aspect provided herein relate to a high voltage direct current (HVDC) bus coupler system. The HVDC bus coupler system can include a monitoring unit to generate fault events. The HVDC bus coupler system can include a pre-charge circuit to charge each energy container in a plurality of energy containers. The HVDC bus coupler system can include an HVDC group to adjust a first configuration of the plurality of energy containers. The HVDC bus coupler system can include a controller. The controller can include one or more processors to receive a signal indicating an event associated with at least one of a plurality of energy containers in a first configuration. The one or more processors can identify a first energy container corresponding to the event. The one or more processors can determine a second configuration of the plurality of energy containers. The one or more processors can modify a configuration of the plurality of energy containers, from the first configuration to the second configuration.

A second aspect provided herein relate to a controller. The controller can include one or more processors to receive a signal indicating an event associated with at least one of a plurality of energy containers in a first configuration. The one or more processors can identify a first energy container corresponding to the event The one or more processors can determine a second configuration of the plurality of energy containers. The one or more processors can modify a configuration of the plurality of energy containers, from the first configuration to the second configuration.

A third aspect provided herein relate to a method of high voltage direct current (HVDC) bus coupling. The method can include receiving, by a controller, a signal indicating an event associated with at least one of a plurality of energy containers in a first configuration. The method can include identifying, by the controller, a first energy container corresponding to the event. The method can include determining, by the controller, a second configuration of the plurality of energy containers. The method can include modifying, by the controller, a configuration of the plurality of energy containers, from the first configuration to the second configuration.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a system for high voltage direct current (HVDC) bus coupling, in accordance with present implementations.

FIG. 2 is a block diagram of a site level architecture using the system for intelligent HVDC bus coupling, in accordance with present implementations.

FIG. 3 is a block diagram of a first configuration of energy containers, in accordance with present implementations.

FIG. 4 is a block diagram of a second configuration of energy containers, in accordance with present implementations.

FIG. 5 is another block diagram of the second configuration of energy containers, in accordance with present implementations.

FIG. 6 is a flowchart showing a method for high voltage direct current (HVDC) bus coupling, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods described herein may be configured, designed, or otherwise arranged to implement High Voltage Direct Current bus coupling to control energy containers and remotely isolate energy containers in the occurrence of a fault event. Furthermore, the systems and methods described herein can facilitate real-time (or near real-time) monitoring of parameters associated with the energy containers (e.g., environmental, electrical) to allow adjustments to the voltage and discharge of the energy content without manual intervention. Inefficient remote isolation of energy containers can cause sitewide shutdowns in the occurrence of the fault event, resulting in significant delays to the output of the worksite. According to the systems and methods described herein, a controller can use various inputs to remotely isolate an energy container associated with a fault event and allow for the site to remain operational while personnel investigate the isolated energy container.

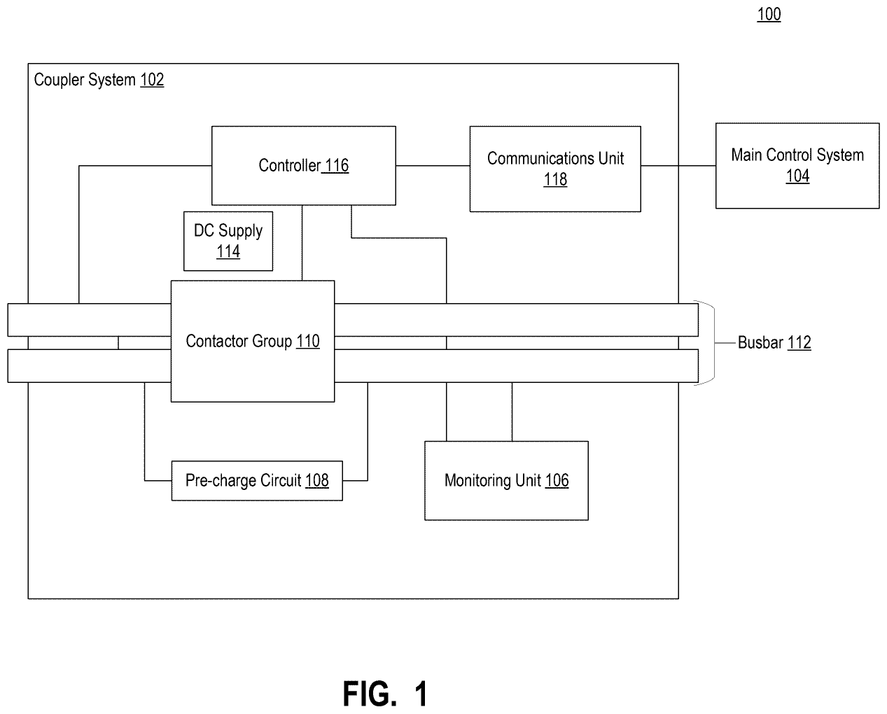

FIG. 1 is a block diagram of a system 100 for intelligent high voltage direct current (HVDC) bus coupling. The system 100 can include at least one coupler system 102 and at least one main control system 104. The coupler system 102 can be any mechanism, device, or hardware designed or configured to connect and disconnect attachments, circuits, busbars, electrical wires, substations, among other components/elements/hardware to electrical power between different sections of an electrical grid. The coupler system 102 can balance loads, isolate faults, and provide a continuous power supply for the system 100. The coupler system 102 can include at least one monitoring unit 106, at least one pre-charge circuit, at least one HVDC contactor group 110, at least one pair of busbars 112, at least one direct current (DC) supply 114, and at least one communications unit 118.

The monitoring unit 106 can be or include hardware configured to monitor energy containers connected via the busbar 112 to detect events (e.g., fault events, thermal runoff event, environmental hazard, fire hazard, etc.) associated with a respective energy container. The monitoring unit 106 can include one or more processors or sensors to generate, create, or otherwise determine signals in the occurrence of an event of at least one energy container. The monitoring unit 106 can include at least one of a voltage sensor, a current sensor, a temperature sensor, a frequency sensor, a phase sensor, a ground fault sensor, among other components/elements / hardware. The monitoring unit 106 can be electrically coupled to the microcontroller 116 to transmit the generated signals.

The pre-charge circuit 108 of the coupler system 102 can be an electronic circuit that charges capacitors of energy containers by routing, diverting, or otherwise directing electrical energy via the busbars 112 for charging corresponding capacitors. The pre-charge circuit 108 can manage current throughout the busbars to prevent, for example, in-rush currents associated with the energy containers. The pre-charge circuit 108 can include a pre-charge resistor, a pre-charge relay, a main relay, a control circuit, among other components/elements/hardware. In operation, the controller 116 can activate the pre-charge relay by connecting the pre-charge resistor in series with the capacitors. From here, the capacitors can charge through the pre-charge resistor. Upon completion of charging the capacitors, the controller 116 can deactivate the pre-charge relay and activate the main relay.

The contactor group 110 can be electrically coupled to the busbars 112 to control the distribution of electrical energy to the components electrically coupled to the busbars 112. The contactor group 110 can include a plurality of contactors, as electrically controlled switches, that can control electrical current to flow through the busbars 112 and prevent electrical current from flowing through the busbars 112. The plurality of contactors can be at least one of electromagnetic contactors, solid-state contactors, reserving contactors, definite purpose contactors, among other components/elements/hardware.

The busbars 112 of the coupler system 102 can be a metal bar, strip, or sheet electrically coupled the various components of the coupler system 102, to distribute electrical current to energy containers of an electrical grid or a worksite. The busbars 112 can include a metallic or electrically and thermally conductive material, such as copper, brass, aluminum, among other materials/elements, configured to efficiently dissipate heat within the system 100. The busbars 112 can directly interact with the contactor group 110 by distributing the electrical current based on the plurality of contactors in a closed state (e.g., switch is closed to allow the transmission of electrical energy).

The DC supply 114 can be a source of electrical energy that provides voltage or current to the various components of the coupler system 102. The DC supply 114 can provide voltage through the busbars 112 to charge energy containers described herein and store energy for other renewable energy sources (e.g., solar panels, wind turbines). The DC supply 114 can include batteries, power adapters, rectifiers, electric circuits, among other components/elements / hardware to provide the current to the components described herein.

The controller 116 can include general purpose single-or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. The controller 116 can be or include a microcontroller. The controller 116 can be electrically coupled to the various components described herein to determine configurations for energy containers within the worksite or electrical grid.

The communications unit 118 can be or include any device, component, element or hardware designed or configured to receive, transmit, or otherwise process signals exchanged between the components of the system 100. For example, the communications unit 118 may include various antennas, transceivers, modems, and associated control logic. The communications unit may be configured to exchange wired and/or wireless signals according to various signaling protocols and on various types of networks. The communications unit 118 can be designed or configured to receive, transmit, or otherwise process signals from the components (e.g., controller 116, monitoring unit 106, contactor group 110) to the main control system 104.

The main control system 104 can be a data center, a safety control room, a security control room, a site operations center, an IT control room, a command center, among other facilities to manager a worksite. The main control system 104 can house a plurality of computing devices or servers to receive signals transmitted by the communications unit 118. Each of the plurality of computing devices can be operated by a control room operator, a supervisor, a maintenance technician, a dispatcher, a security office, among other personnel to monitor and manage the worksite, to respond to the occurrence of a fault event.

The system 100 is not confined to the components described herein and can include additional or alternate components, not shown for brevity, which are to be considered within the scope of the embodiments described herein.

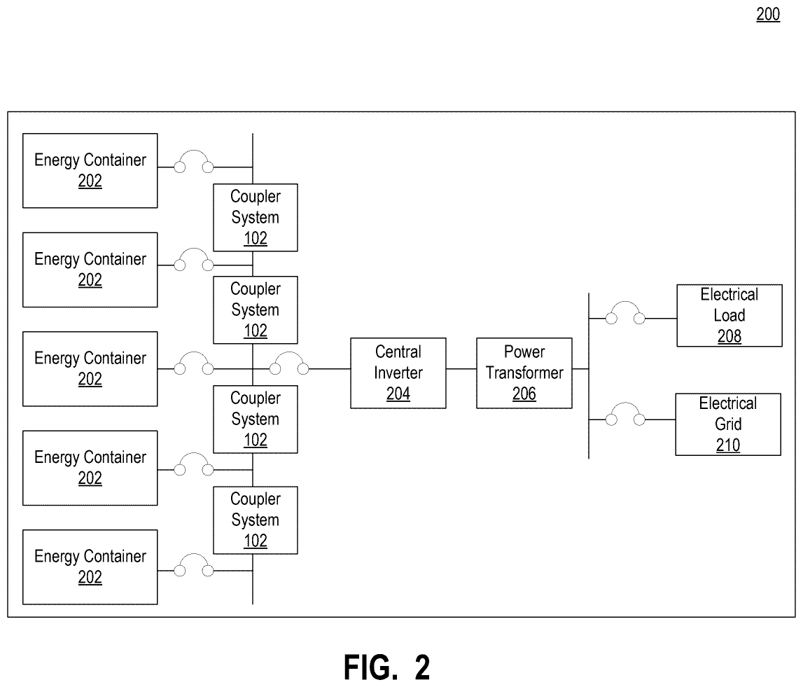

FIG. 2 is a block diagram of a site level architecture 200 using the system for intelligent HVDC bus coupling. The site level architecture 200 can correspond to a physical layout of various renewable energy sources at a worksite. The physical layout can include a design or organization of the components, devices, machines, and connectivity of the components described herein. The site level architecture 200 can include at least one energy container 202, at least one coupler system 102, at least one central inverter 204, at least one power transformer 206, at least one electrical load 208, and at least one electrical grid 210.

The energy containers 202 can be configured or designed to store energy generated from renewable energy sources (e.g., hydro, solar, wind, mechanical) and distribute the energy according to the demands of the site level architecture 200. The energy containers 202 can utilize a plurality of energy storage systems, such as battery energy storage (e.g., Lithium-ion batteries, lead-acid batteries, Flow batteries, Nickel-cadmium), mechanical energy storage (e.g., pumped hydro, compressed air energy, flywheel energy), thermal energy storage (e.g., molten salt, ice, phase change), chemical energy (e.g., Hydrogen, Synthetic natural gas), among other types of energy. Within the site level architecture 200, the energy containers 202 can be electrically coupled to at least one coupler system 102.

The energy containers 202 can be interconnected in series and parallel through the plurality of coupler systems 102. By exploiting the series and parallel connections, the systems and methods described herein can isolate energy containers that are subject to a fault event (hereinafter referred to as an “event”), without sacrificing the performance and efficiency of the site level architecture 200. Furthermore, interconnecting the energy containers 202 in series and in parallel can facilitate the site maintaining optimal efficiency distribution from energy containers, particularly where one or more of the energy containers experience an event, to minimalize manual intervention.

The central inverter 204 can be a component electrically couped to each coupler system 102 within the site level architecture 200. The central inverter 204 may be designed or configured to convert the DC electricity into alternating current (AC) electricity for various loads associated with the site level architecture 200. In other words, the central inverter 204 may be or include one or more DC-to-AC converters/inverters. The central inverter 204 can be designed according to one or more specifications of the site level architecture 200 (e.g., power capacity, efficiency, environmental conditions, etc.).

The power transformer 206 can be an electric device or component to transfer electrical energy from the central inverter 204 to the electrical load 208 and/or the electrical grid 210. The power transformer 206 can include a core, windings, insulation, a tank, a tap charger, a cooling system, among other components/elements/hardware. The power transformer 206 can utilize electromagnetic induction to complete the transfer of electrical energy. The power transformer 206 can execute voltage conversion to step up/down voltage levels, isolation to provide electrical isolation between circuits, and impendence matching to maximize power transfer.

The electrical load 208 can be any component, device, machine, or equipment that consumes electrical power within the site level architecture 200. For example, the electrical loads 208 can be drills, saws, grinders, transformers, sanders, generators, electrical vehicles, heavy machinery, among other components/elements/hardware. The electrical load 208 can convert electrical energy from the power transformer 206 into other forms of energy (e.g., heat, lights, or mechanical motion). The electrical loads 208 can include resistive loads, inductive loads, capacitive loads, combination loads, among other components/elements/hardware.

The electrical grid 210 can be or include a localized or contained power grid dedicated for a particular region. The electrical grid 210 can include various power sources (e.g., received via the power transformer 206) which supply power to the electrical grid 210 for distribution in the localized/contained area. For example, the electrical grid 210 may include power sources, including utilities, generator sets, and renewable power sources. Various combinations of such power sources can supply power to the electrical grid 210 to supply power to the localized/contained area.

Still referring to FIG. 2, with continued reference to FIG. 1, the monitoring unit 106 can monitor, record, or otherwise track one or more control parameters of each energy container 202 in the plurality of energy containers 202 to transmit to the main control system 104. The one or more control parameters can include a state of charge, a state of health, a charge rate, a discharge rate, a temperature, voltage levels, current flow, among other factors. To monitor each energy container 202, the monitoring unit 106 can receive the one or more control parameters from sensors attached to or otherwise arranged to monitor parameters of the energy containers 202. For example, the sensors of the energy container 202 can transmit the state of charge to the monitoring unit 106. Upon reception of the state of charge, the monitoring unit 106 can transmit the state of charge to the main control system 104 via the controller 116 and the communications unit 118.

The communications unit 118 can transmit, provide, or otherwise send data from the monitoring unit 106 to a computing device of the main control system 104. In operation, the monitoring unit 106 can start a data transmission to transmit data (e.g., control parameters) to the main control system 104. During the data transmission, the communications unit 118 can receive, retrieve, or otherwise obtain the data from the monitoring unit 106. Concurrently, the communications unit can store, house, buff, or otherwise maintain the data within a local storage (e.g., cache memory). Once the data transmission is complete, the communications unit 118 can provide, send, or otherwise transmit a packet/frame/information to the main control system 104 to display the control parameters on a user interface of the computing device. For example, the communications unit 118 can provide the state of charge and the charge rate for the energy containers as data within the user interface of a computing device associated with the main control system 104. An administrator, manager, technician, or worker interacting with the main control system 104 can use the user interface to request maintenance, report an event, or cause the controller 116 to isolate at least one energy container 202.

The controller 116 can obtain, detect, or otherwise receive a signal from the monitoring unit 106. The monitoring unit 106 can transmit, generate, or otherwise provide the signal in response to detecting an event. The signal can be a wireless, a wired, or any kind of signal transmitting data from one component to another component. For example, the signal can be transmitted via a controller area network bus. In another example, the signal can be transmitted via Wi-Fi using a network. In another example, the controller 116 can electronically receive the signal from the monitoring unit 106, the communications unit 118, or other components of the coupler system 102.

The signal can be a variation in voltage, current, or electromagnetic waves, such as analog signals or digital signals, between the various components described above. The signal can indicate the event associated with at least one energy container 202 of a plurality of energy containers 202. The event can be at least one of a short circuit event (e.g., worn or damaged insulation, overheated wires, loose connections, water ingress, overloaded power strips, pinched wires, etc.), a thermal runoff event (e.g., lithium ion battery heating, overcharging, overheating, temperature increase, rate of change of temperature increase, etc.), or an earth fault event (e.g., flooding, mudslides, lightning strikes, hurricanes, etc.). For example, an energy container 202 can include a short-circuit, thereby, triggering the monitoring unit 106 to generate and transmit the signal to the controller 116. In another example, an energy container 202 may be damaged in a mudslide, thereby, triggering the monitoring unit 106 to generate and transmit the signal to the controller 116.

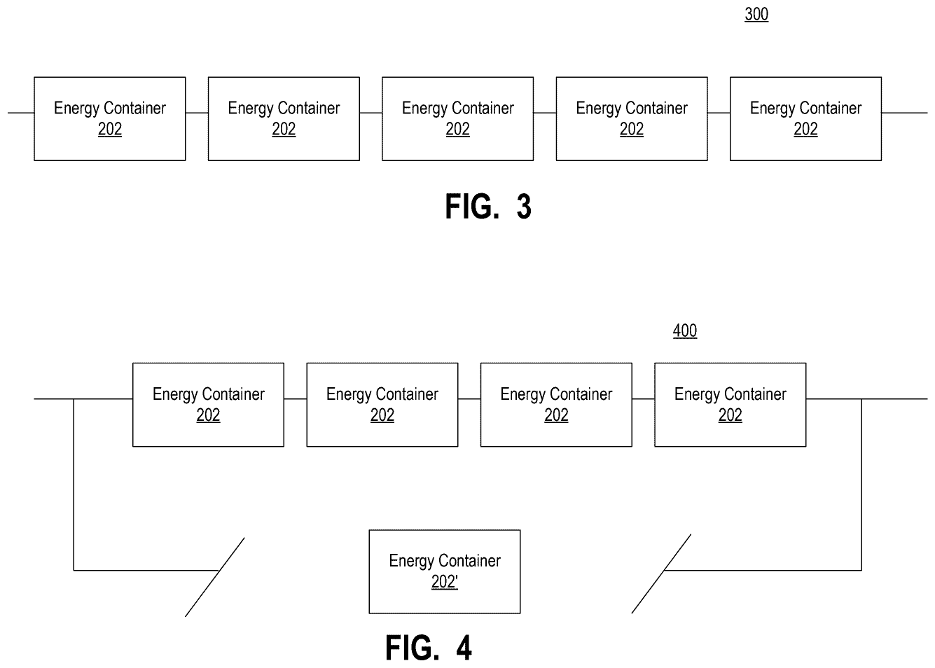

The signal can indicate the event associated with at least one energy container 202 of a plurality of energy containers 202 in a first configuration. For example, the signal can indicate a short circuit event associated with a first energy container 202 while in the first configuration for the plurality of energy containers 202. The first configuration can correspond an organization of each energy container 202 based on needs of the electrical load 208 and the electrical grid 210. For example, the site level architecture 200 can include a first energy container 202, a second energy container 202, and third energy container 202. The configuration can indicate that the second energy container is placed after the first energy container, but prior to the third energy container. FIG. 3 is a block diagram of the first configuration 300 of energy containers 202. The first configuration 300 is shown to include five energy containers, but it is understood that this is by example and the systems and methods described herein are not limited to first configuration 300.

The controller 116 can identify, indicate, or otherwise designate the first energy container 202 corresponding to the event by using the signal from the monitoring unit 106 and one or more control parameters of each energy container 202. For example, the signal can indicate that a thermal runoff event (e.g., battery overheating) has occurred within the site level architecture 200. The controller 116 can access the one or more control parameters (e.g., temperature, power output) of each energy container 202 to identify the energy container with the highest temperature and the lowest power output. In another example, the signal can indicate that a short circuit event has occurred within the site level architecture 200. The controller 116 can access the one or more control parameters (e.g., current flow, low impedance) of each energy container 202 to identify the energy container 202 with the highest current flow and the lowest impedance. In another example, the controller 116 can use one or more sensors on each energy container 202 to detect a voltage spike or a current drop within at least one energy container 202. From here, the monitoring unit 106 can generate the signal in accordance with the voltage spike or current drop.

The controller 116 can identify, indicate, or otherwise designate the first energy container 202 corresponding to the event based on a change of the one or more control parameters. The controller 116 can calculate a delta between a previous value of the one or more control parameters and a current value of the one or more control parameters. From here, the controller 116 can compare the delta to a threshold. In response to the delta exceeding the threshold, the controller 116 can identify the respective energy container 202. For example, the controller 116 can calculate a delta for the voltage level associated with a first energy container 202. The delta can exceed the threshold for voltage signifying an open circuit event at the respective energy container 202.

The controller 116 may generate a flag to designate the first energy container 202 associated with the event. The flag can be an indicator, a warning, a code, a label, among other elements. For example, once the controller 116 identifies the first energy container 202 corresponding to the event, the controller 116 may generate a flag to transmit to the first energy container 202. Once transmitted, the controller 116 can flag the first energy container 202. The controller 116 can transmit the flagged energy container 202 to the main control system 104 using the communications unit 118, thereby allowing a technician to report to the flagged energy container 202. In this manner the controller 116 can provide the flagged energy container 202 to the user interface of the computing device at the main control system 104.

The controller 116 can determine, calculate, or otherwise generate a second configuration of the plurality of energy containers. The second configuration can correspond to an organization of each energy container 202 based on needs of the electrical load 208 and the electrical grid 210 while isolating or removing at least one energy container 202 from the site level architecture 200. Using the needs of the electrical load 208 and the electrical grid 210, the controller 116 can generate an operating threshold to operate the site level architecture 200 despite including an isolated energy container 202'. The operating threshold can be a minimum amount of energy at the power transformer 206 to power the electrical load 208 and the electrical grid 210. For example, the controller 116 can use the electrical load 208 and the electrical grid 210 to identify an operating threshold. From here the controller 116 can use the communications unit 118 to report the control parameters of the energy containers 202 and the operating threshold to the main control system 104.

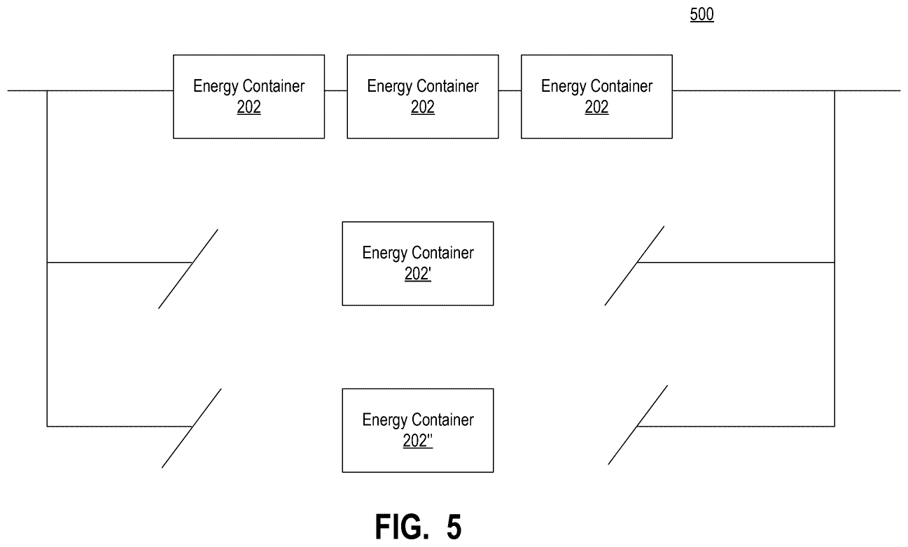

Upon establishing the operating threshold, the controller 116 can calculate the plurality of configurations, excluding the at least one energy container 202 associated with the event, that satisfy the operating threshold. For example, the controller 116 can calculate a first configuration, a second configuration, and a third configuration for the energy containers 202. Each of the configurations can isolate the at least one energy container 202 associated with the event while satisfying the operating threshold. From here, the controller 116 can select either the first configuration, the second configuration, or the third configuration for the site level architecture 200. FIG. 4 and FIG. 5 are block diagrams of the second configuration. As shown in FIG. 4, the second configuration 400 can include one isolated energy container 202'. As shown in FIG. 5, the second configuration 500 can include two isolated energy containers 202.

The controller 116 can modify the configuration of the energy containers 202 from the first configuration 300 to the second configuration 400 by adjusting the plurality of contactors within the contactor group 110. For instance, by adjusting the plurality of contactors within the contactor group 110, the coupler system can disconnect electrical energy provided by the DC supply 114 and the pre-charge circuit 108, thereby, decoupling electrical energy from the busbar 112. Once decoupled, the busbar 112 cannot conduct electrical energy through the coupler system 102, therefore, isolating the energy container 202 connected to the coupler system 102. Since the energy containers 202 are connected in series and in parallel through the coupler system 102, a controller 116 of the respective coupler system 102 can isolate the energy container 202 associated with the event while maintain the operational threshold. As a result of isolating the energy container 202 associated with the event, the site level architecture 200 can transition from the first configuration, as shown in FIG. 3, to the second configuration 400 as shown in FIG. 4.

Concurrently, the controller 116 can transmit, send, or otherwise provide a signal to the main control system 104 via the communications unit 118. The signal can indicate that the configuration of the plurality of energy containers 202 in the first configuration 300 is being modified to the second configuration 400. For example, while modifying the first configuration 300 to the second configuration 400, the controller 116 can generate and transmit a signal to the main control system 104. Upon reception of the signal, the main control system 104 can determine, contact, or otherwise identify the personnel (e.g., worker, technician, specialist) to investigate the event associated with the isolated energy container 202′ based on the signal. The signal can identify the event associated with the isolated energy container 202′. For example, if the signal indicates a short circuit event, the main control system 104 can identify an electrician to investigate the short circuit event associated with the isolated energy container 202′. In another example, if the signal indicates a thermal event, the main control system 104 can identify a hazmat team to investigate the short circuit event associated with the isolated energy container 202′. This aspect of the technical solution described herein reduces the amount of time before authorized personnel can investigate the event associated with the isolated energy container 202′ without sacrificing the production of the site 200.

Once the energy containers 202 are in the second configuration 400, the controller 116 can adjust a voltage of the non-isolated energy containers 202 at the site 200 to operate above an operational threshold. The operational threshold can show a minimum energy output of the non-isolated energy containers 202 to satisfy the needs of the electrical grid 210 and the electrical load 208. While the energy containers 202 are in the first configuration 300, the energy containers 202 can be configured to operate at the operational threshold according to the needs of the electrical grid 210 and the electrical load 208. However, upon isolation of the at least one energy container 202, the non-isolated energy containers 202 may need to increase the one or more control parameters to operate at the operational threshold at the site 200 to satisfy the needs of the electrical load 208 and the electrical grid 210. Therefore, the controller 116 can calculate a rate to adjust the one or more control parameters to maintain the operational threshold. For example, the controller 116 can double the voltage of the non-isolated energy containers 202 to satisfy the needs of the electrical load 208 and the electrical grid 210.

In some instances, multiple events can occur at the site 200 at different times. Therefore, the monitoring unit 106 can transmit, send, or otherwise provide a signal in response a subsequent event to the controller 116. The subsequent event can be at least one of a short circuit event (e.g., worn or damaged insulation, over heated wires, loose connections, water ingress, overloaded power strips, pinched wires, etc.), a thermal runoff event (e.g., lithium ion battery overheating, overcharging, overheating, drastic temperature increase, etc.), or an earth fault event (e.g., flooding, mudslides, lightning strikes, hurricanes, etc.). For example, an energy container 202 can have a short-circuit, thereby triggering the monitoring unit 106 to generate and transmit the signal to the controller 116. In another example, an energy container 202 may overheat, thereby, triggering the monitoring unit 106 to generate and transmit the signal to the controller 116.

When the controller 116 receives the signal, the signal can indicate the subsequent event associated with at least one energy container 202 of a plurality of energy containers 202 in a first configuration. For example, the signal can indicate a short circuit event associated with a second energy container 202 while in the second configuration 400 for the plurality of energy containers 202. The second configuration can correspond an organization of each energy container 202 based on needs of the electrical load 208 and the electrical grid 210, while the first energy container 202 is isolated. For example, the site level architecture 200 can include a first energy container 202, a second energy container 202, third energy container 202, and a fourth energy container 202. The configuration can indicate that the second energy container 202 is placed after the first energy container 202, but prior to the third energy container 202, with the fourth energy container 202 being isolated as shown in FIG. 4.

The controller 116 can identify, indicate, or otherwise designate the second energy container 202 corresponding to the subsequent event by using the signal from the monitoring unit 106 and the one or more control parameters of each energy container 202. For example, the signal can indicate that a thermal runoff event (e.g., battery fire) has occurred within the site level architecture 200. The controller 116 can access the one or more control parameters (e.g., temperature, power output) of each energy container 202 to identify the energy container with the highest temperature and the lowest power output. In another example, the signal can indicate that a short circuit event has occurred within the site level architecture 200. The controller 116 can access the one or more control parameters (e.g., current flow, low impedance) of each energy container 202 to identify the energy container 202 with the highest current flow and the lowest impedance.

The controller 116 may generate a flag to designate the second energy container 202 associated with the subsequent event. The flag can be an indicator, a warning, a code, a label, among other elements. For example, once the controller 116 identifies the second energy container 202 corresponding to the subsequent event, the controller 116 may generate a warning to transmit to the first energy container 202. Once transmitted, the controller 116 can flag the second energy container 202. The controller 116 can transmit the flagged energy container 202 to the main control system 104 using the communications unit 118, thereby, allowing a technician to report to the flagged energy container 202. In this manner the controller 116 can provide the flagged energy container 202 to the user interface of the computing device at the main control system 104.

The controller 116 can determine, calculate, or otherwise generate a third configuration (e.g., similar to second configuration 500) of the plurality of energy containers. The third configuration 500 can correspond to an organization of each energy container 202 based on needs of the electrical load 208 and the electrical grid 210 while isolating or removing at least one subsequent energy container 202 from the site level architecture 200. Using the needs of the electrical load 208 and the electrical grid 210, the controller 116 can generate an operating threshold to operate the site level architecture 200 despite including multiple isolated energy containers 202. The operating threshold can be a minimum amount of energy at the power transformer 206 to power the electrical load 208 and the electrical grid 210. For example, the controller 116 can use the electrical load 208 and the electrical grid 210 to identify an operating threshold. From here the controller 116 can use the communications unit 118 to report the control parameters of the energy containers 202 and the operating threshold to the main control system 104.

Upon establishing the operating threshold, the controller 116 can calculate the plurality of configurations, excluding the at least two energy containers 202 associated with the subsequent event, that satisfy the operating threshold. For example, the controller 116 can calculate a first configuration, a second configuration, and a third configuration for the energy containers 202. Each of the configurations can isolate the at least two energy containers 202 associated with the subsequent event while satisfying the operating threshold. From here, the controller 116 can select either the first configuration, the second configuration, or the third configuration 500 for the site level architecture 200 as shown in FIG. 5.

The controller 116 can modify the configuration of the energy containers 202 from the second configuration 400 to the third configuration 500 by adjusting the plurality of contractors within the contactor group 110. For instance, by adjusting the plurality of contactors within the contactor group 110, the coupler system can disconnect electrical energy provided by the DC supply 114 and the pre-charge circuit 108, thereby, decoupling electrical energy from the busbar 112. Once decoupled, the busbar 112 cannot conduct electrical energy through the coupler system 102, therefore, isolating the energy container 202 connected to the coupler system 102. Since the energy containers 202 are connected in series and in parallel through the coupler system 102, a controller 116 of the respective coupler system 102 can isolate the energy container 202″ associated with the subsequent event while maintaining the operational threshold by selectively connecting the energy containers in one or more series-parallel connections. As a result of isolating the energy container 202″ associated with the subsequent event, the site level architecture 200 can transition from the second configuration, as shown in FIG. 4, to the third configuration 500 as shown in FIG. 5. In this manner, the first configuration 300 of the plurality of energy containers 202 differs from the second configuration 400 of the plurality of energy containers 202 and the second configuration 400 of the plurality of energy containers 202 differs from the third configuration 500 of the plurality of energy containers 202.

After the personnel respond to the at least one isolated energy container 202 to remove/mitigate/terminate the event, the controller 116 can test the isolated energy container 202 (e.g., first energy container 202) to determine whether the isolated energy container 202 associated with the event has been resolved. For example, a technician can fix an isolated energy container 202 associated with a short circuit event. Once the isolated energy container 202 is fixed, the controller 116 can test the energy container 202, by running low levels of current through the energy container 202. Based on the test, the controller 116 can determine that the isolated energy container 202 associated with the short circuit event has been resolved, despite having repairs by the technician. If the isolated energy container 202 associated with the short circuit event has not been resolved, the controller 116 can use the communications unit 118 to transmit a signal to the main control system 104.

Continuing on, if the energy container 202 associated with the event (e.g., short circuit event) has been resolved, the controller 116 can modify the third configuration 500 to include the isolated energy container 202. For example, after repairs by a technician, the controller 116 can determine that the isolated energy container 202 does not associate with the event. Responsive to the determination, the controller can modify the third configuration 500 to include the isolated energy container 202. To include the isolated energy container, the controller 116 can adjust the voltage of each non isolated energy container 202 within the third configuration 500. By adjusting the voltage, the controller 116 can reduce strain and increase longevity of the energy containers 202 within the site 200.

### INDUSTRIAL APPLICABILITY

The disclosed embodiments may be applicable to any High Voltage Direct Current (HVDC) bus coupling based system or solution. For example, the disclosed embodiments may be applicable to or applied to a worksite, such as a construction site, mining operations, drilling sites, a power plant, renewable energy sources, transmission towers, relays, a power source for a home, a power source for the office, or any other residential/industrial setting, or any other power delivery system which may include an HVDC bus. The disclosed embodiments may be applicable to electrical system which use or include HVDC bus coupling, or HVDC systems which struggle to control each energy container at the site level, and to remotely actuate and/or configure the coupling mechanisms between energy containers as per system requirements. The disclosed controller 116 can be provided to efficiently control and optimize the energy containers at the site level when fault events occur by modifying the configuration of the energy containers by using a plurality of contactors within a HVDC contactor group 110. For example, the controller 116 can open one or more contactors within the contactor group 110 to decouple an energy container associated with the fault event.

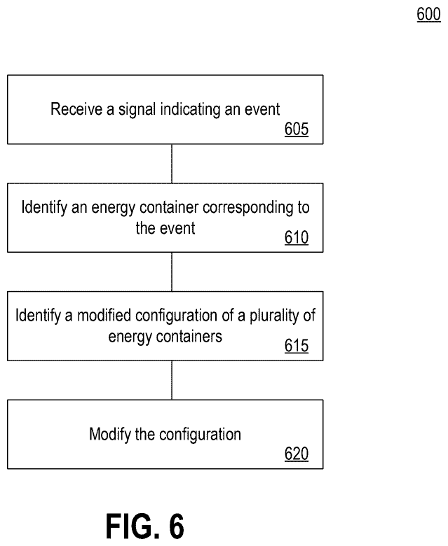

Referring now to FIG. 6, depicted is a flowchart showing an example method 600 high voltage direct current (HVDC) bus coupling. The method 600 may be performed by, implemented on, or otherwise executed by the components, elements, or hardware described above with reference to FIGS. 1-5. For example, the method 600 may be executed by the components of FIG. 1 and FIG. 2. As a brief overview, at step 605, the controller 116 can receive a signal indicating an event. At step 610, the controller 116 can identify an energy container corresponding to the event. At step 615, the controller 116 can identify a modified configuration of a plurality of energy containers. At step 620, the controller 116 can modify the configuration.

At step 605, the controller 116 can receive a signal indicating an event from a monitoring unit 106 associated with at least one of a plurality of energy containers in a first configuration. The monitoring unit 106 can generate the signal by monitoring one or more control parameters of each energy container to detect changes in state of charge, state of health, power output, longevity, among other elements, that reduce the output of the energy containers below an operation threshold. The controller 116 can provide data that includes the one or more control parameters to a user interface of a computing device associated with a main control system 104. Based on the one or more control parameters, the monitoring unit 106 can determine the event associated with the at least one of a plurality of energy containers.

At step 610, the controller 116 can identify a first energy container corresponding to the event. The monitoring unit 106 can report the one or more control parameters of each energy container for analysis by the controller 116. The controller 116 can compare the one or more control parameters to a threshold for the one or more control parameters. From here, the controller 116 can compare the one or more control parameters to the threshold to mark or label the respective energy container as corresponding to the event, responsive to the one or more control parameters of the respective energy container being less than the threshold.

At step 615, the controller 116 can identify a modified configuration of the plurality of energy containers. The modified configuration can differ from the first configuration. The controller 116 can use the plurality of contactors within the HVDC contactor group 110 to isolate the energy container associated with the event in the modified configuration. The controller 116 can determine that the fault event causes the site to operate below a threshold by isolating the energy container. The controller 116 can calculate a rate to adjust the one or more control parameters of the non-isolated energy continues to operate the site above the threshold. The controller 116 can iterate through a plurality of configurations based on the one or more control parameters of each non-isolated energy containers within the site. Upon completion of the iteration process, the controller can select a new configuration for the plurality of energy containers. The new configuration can exclude the isolated energy container.

At step 620, the controller 116 can modify the configuration of the plurality of energy containers. To modify the configuration, the controller 116 can selectively connect the non-isolated energy containers in one or more series or parallel connections. Once the non-isolated energy containers are connected, the controller 116 can adjust the one or more control parameters of the non-isolated energy containers to operate above the threshold. The controller 116 can use a communications unit 118 to transmit a signal to the main control system 104 to identify personnel to fix the isolate energy container.

From here, the main control system 104 can identify personnel to fix the isolated energy container. Once the isolated energy container is fixed, the controller 116 can test the isolated energy container to determine that the isolated energy container satisfies a threshold to operate within the site.

If the isolated energy container does not satisfy the threshold to operate within the site, the controller 116 can use a communications unit 118 to transmit another signal to the main control system 104, thereby trigger the main control system 104 to send personnel to further investigate the isolated energy container. During this process, and in various instances, the monitoring unit 106 can generate and transit a second signal indicating a second event associated with another energy container in the new configuration. The controller 116 can identify a second energy container corresponding to the second event. The monitoring unit 106 can report the one or more control parameters of each energy container for analysis by the controller 116. The controller 116 can compare the one or more control parameters to a threshold for the one or more control parameters. From here, the controller 116 can compare the one or more control parameters to the threshold to mark or label the respective energy container as corresponding to the second event, responsive to the one or more control parameters of the respective energy container being less than the threshold.

The controller 116 can identify a second modified configuration of the plurality of energy containers. The second modified configuration can differ from the modified configuration (e.g., of step 615). The controller 116 can use the plurality of contactors within the HVDC contactor group 110 to isolate the energy container associated with the second event in the second modified configuration. Again, the controller 116 can iterate through a plurality of configurations based on the one or more control parameters of each non-isolated energy containers within the site. Upon completion of the iteration process, the controller can select a new configuration for the plurality of energy containers. The new configuration can exclude the isolated energy containers. In this manner, the controller 116 can isolate multiple energy containers.

If the isolated energy container satisfies the threshold to operate within the site, the controller 116 can adjust the one or more circuits to reintroduce the isolated energy container into site. Thereby, allowing the controller 116 to adjust the one or more control parameters of the energy containers to reduce strain at the site. By using the systems and methods described herein to control the energy containers at the site by reducing time to investigate events at the respective energy containers, improve efficient use of the energy containers, and increase longevity of the component s of the worksite without sacrificing demands of an electrical grid. Overall, the systems and methods described herein provide improvement to the management and control of energy containers at a worksite.

What is claimed is:

1. A high voltage direct current (HVDC) bus coupler system, comprising:
a monitoring unit to detect fault events; and
a controller comprising one or more processors configured to:
receive a signal indicating an event associated with at least one of a plurality of energy containers in a first configuration;
identify a first energy container corresponding to the event;
determine a second configuration of the plurality of energy containers; and
modify a configuration of the plurality of energy containers, from the first configuration to the second configuration.

2. The HVDC bus coupler system of claim 1, wherein the controller is configured to transmit, to a main control system, a second signal to cause the main control system to identify personnel to report to the first energy container, the second signal indicating the event.

3. The HVDC bus coupler system of claim 1, wherein the controller is configured to:
monitor one or more control parameters of each energy container of the plurality of energy containers; and
provide to a user interface of a computing device, data including the one or more control parameters of each energy container.

4. The HVDC bus coupler system of claim 1, wherein the controller is configured to:
receive a second signal indicating a second event associated with at least one of the plurality of energy containers in the second configuration;
identify a second energy container corresponding to the second event;
determine a third configuration of the plurality of energy containers; and
modify the configuration of the plurality of energy containers, from the second configuration to the third configuration.

5. The HVDC bus coupler system of claim 4, wherein the first configuration of the plurality of energy containers differs from the second configuration of the plurality of energy containers, wherein the second configuration of the plurality of energy containers differs from a third configuration of the plurality of energy containers.

6. The HVDC bus coupler system of claim 4, wherein the controller is configured to:
determine whether the first energy container associates with the event; and
responsive to the first energy controller not associating with the event, modify the third configuration to include the first energy container.

7. The HVDC bus coupler system of claim 1, wherein, when modifying the configuration, the controller is configured to adjust one or more contactors within an HVDC group to isolate the first energy container.

8. The HVDC bus coupler system of claim 1, wherein the controller is configured to:
determine that the fault event causes a site to operate below a threshold; and
calculate a rate to adjust one or more control parameters of each energy container at the site to operate above the threshold.

9. The HVDC bus coupler system of claim 1, wherein, when receiving the signal further comprising:
detect, via one or more sensors, at least one of a voltage spike or a current drop at the first energy container of the plurality of energy containers; and
generate the signal in accordance with the voltage spike or the current drop.

10. The HVDC bus coupler system of claim 1, wherein each energy container of the plurality of energy containers are selectively connected in series and in parallel, and wherein the configuration is modified by selectively connecting the energy containers in one or more series-parallel connections.

11. The HVDC bus coupler system of claim 1, wherein the second configuration excludes the first energy container from a set of energy containers which supply energy to the HVDC bus

12. The HVDC bus coupler system of claim 1, wherein the fault event includes at least one of a short circuit event, a thermal event, and an earth fault event.

13. A controller for a high voltage direct current (HVDC) bus coupler system, comprising one or more processors configured to:
receive a signal indicating an event associated with at least one of a plurality of energy containers in a first configuration;
identify a first energy container corresponding to the event;
determine a second configuration of the plurality of energy containers; and
modify a configuration of the plurality of energy containers, from the first configuration to the second configuration.

14. The controller of claim 13, wherein the one or more processors are configured to:
transmit, to a main control system, a second signal to cause the main control system to identify personnel to report to the first energy container, the second signal indicating the event.

15. The controller of claim 13, wherein the one or more processors are configured to:
monitor one or more control parameters of each energy container of the plurality of energy containers; and
provide to a user interface of a computing device, data including the one or more control parameters.

16. The controller of claim 13, wherein the one or more processors are configured to:
receive a second signal indicating a second event associated with at least one of a plurality of energy containers in the second configuration;
identify a second energy container corresponding to the second event;
determine a third configuration of the plurality of energy containers; and
modify a configuration of the plurality of energy containers, from the second configuration to the third configuration.

17. The controller of claim 13, wherein the first configuration of the plurality of energy containers differs from the second configuration of the plurality of energy containers, wherein the second configuration of the plurality of energy containers differs from the third configuration of the plurality of energy containers.

18. The controller of claim 16, wherein the one or more processors are configured to:
determine that the first energy container satisfies a threshold to operate within an electrical grid; and
responsive to the first energy controller satisfying the threshold, modify the third configuration to include the first energy container.

19. The controller of claim 13, wherein, when modifying the configuration, the one or more processors are configured to adjust one or more circuits connecting the plurality of energy containers, to isolate the first energy container.

20. A method for high voltage direct current (HVDC) bus coupling, comprising:
receiving, by a controller, a signal indicating an event associated with at least one of a plurality of energy containers in a first configuration;
identifying, by the controller, a first energy container corresponding to the event;
determining, by the controller, a second configuration of the plurality of energy containers; and
modifying, by the controller, a configuration of the plurality of energy containers, from the first configuration to the second configuration.
